(19) United States
(12) Patent Application Publication
(10) Pub. No.: US 2024/0146526 A1
(43) Pub. Date: May 2, 2024

(54) MANAGEMENT OF TENANT-SPECIFIC ENCRYPTION KEYS

(71) Applicant: SAP SE, Walldorf (DE)

(72) Inventors: Martin SCHINDEWOLF, Walldorf (DE); Meinolf BLOCK, Heidelberg (DE); Sascha ZORN, Neulussheim (DE); Christoph HOHNER, Schwetzingen (DE)

(21) Appl. No.: 17/979,206

(22) Filed: Nov. 2, 2022

(51) Int. Cl. H04L 9/08

(52) U.S. Cl. CPC H04L 9/0894; H04L 9/0822

(57) ABSTRACT

Systems and methods include assignment of first data artifacts stored in a volatile memory to a first database tenant object instance stored in the volatile memory, storage, in a persistent storage system, of a first payload database comprising a first encryption key for encrypting and decrypting the first data artifacts, storage, in the persistent storage system, a second payload database comprising a second encryption key for encrypting and decrypting second data artifacts not assigned to a database tenant object instance, and storage, in the persistent storage system, of a configuration database comprising a first portion including information usable for decrypting the first encryption key and a second portion including information usable for decrypting the second encryption key.

### BACKGROUND

Multi-tenancy is a software architecture pattern which facilitates the sharing of computing resources among disparate groups of users. For example, a single multi-tenant application (e.g., a Software-as-a-Service (SaaS) application) may serve multiple end user groups (i.e., customers) independently within a single software instance. Such a software instance uses a much smaller computing resource footprint than would be required to provision one software instance per customer. Multi-tenancy can therefore provide substantial cost benefits.

The data of each customer in a multi-tenant architecture is typically mapped to a corresponding tenant in the underlying data layer. This mapping allows for logical separation of the data within the data layer and facilitates access thereto by the multi-tenant application. In some multi-tenant architectures, the data of each tenant is managed by a different database instance executing within a same computing system (e.g., a rack server). These architectures provide excellent separation of tenant data but it may be cost-inefficient in some scenarios to require a full database instance per tenant. For example, a smallest database instance may consume 32Gb of memory, which may represent significantly more computing resources than should be required by a small tenant.

Other multi-tenant data architectures use a single database instance to manage the data of multiple tenants. Since the data in such an architecture is not physically separated, the multi-tenant application is responsible for storing and managing the data in a tenant-aware manner. For example, a database system may use one schema of a single instance for all tenants, where the data of each tenant is partitioned via a discriminating column. The multi-tenant application uses the values of the discriminating column to identify the data which belongs to specific tenants. In another example, the multi-tenant application associates a dedicated schema to each tenant. In either case, the database system is unaware of the existence of the multiple tenants and operates in the same manner as if it were being accessed by a single-tenant application.

Data volumes and log segments of a database system may be persisted to disk. This data, which includes all the customer (i.e., tenant) data stored in the database system as well as data and metadata not specific to any customer, is conventionally encrypted using a key associated with the database system (i.e., a data encryption key) prior to storage thereof on disk. The data encryption key is generated by a provider of the database system and its corresponding decryption key is stored local to the database.

Recent systems provide such database-instance-level encryption features on a tenant-level, where the data of each database tenant is encrypted with its own tenant-specific key. However, use of a database-specific key chain and multiple tenant-specific key chains by a single database instance presents challenges. Such challenges include preventing one tenant from accessing another tenant's key chain, allowing selective revocation of one or more tenant-specific key chains, supporting selective backup and restoration of one or more tenant-specific key chains, and allowing different tenants to use different key management systems to protect their tenant-specific keys.

### BRIEF DESCRIPTION OF THE DRAWINGS

FIG. 1 is a block diagram of a database system providing management of tenant-specific keys within a secure store according to some embodiments.

FIG. 2 is a diagram of a file directory including configuration and payload databases according to some embodiments.

FIG. 3 is a flow diagram of a process for creating tenant-specific keys according to some embodiments.

FIG. 4A illustrates a secure store storing a configuration database and a payload database after database creation according to some embodiments.

FIG. 4B is a diagram of a file directory including storing a configuration database and a payload database after database creation according to some embodiments.

FIG. 5A illustrates a secure store storing a configuration database and a payload database after creation of a first tenant according to some embodiments.

FIG. 5B is a diagram of a file directory including storing a configuration database and a payload database after creation of a first tenant according to some embodiments.

FIG. 6A illustrates a secure store storing a configuration database and a payload database after creation of a second tenant according to some embodiments.

FIG. 6B is a diagram of a file directory including storing a configuration database and a payload database after creation of a second tenant according to some embodiments.

FIG. 7A illustrates a secure store storing a configuration database and a payload database after deletion of a first tenant according to some embodiments.

FIG. 7B is a diagram of a file directory including storing a configuration database and a payload database after deletion of a first tenant according to some embodiments.

FIG. 8 is a flow diagram of a process for creating tenants in a multi-process database system according to some embodiments.

FIG. 9 is a flow diagram of a process for deleting tenants in a multi-process database system according to some embodiments.

FIG. 10 is a block diagram of a database system architecture providing management of tenant-specific and database-specific keys within a secure store in conjunction with a key management system according to some embodiments.

FIG. 11 is a block diagram of a database system architecture providing management of tenant-specific and database-specific keys within a secure store in conjunction with two key management systems according to some embodiments.

FIG. 12 is a block diagram of a cloud-based system according to some embodiments.

### DETAILED DESCRIPTION

The following description is provided to enable any person in the art to make and use the described embodiments. Various modifications, however, will be readily-apparent to those in the art.

Generally, all database instance data not actively being processed (i.e., data “at rest”) resides encrypted in persistent storage, where the data of each tenant of the database instance is encrypted with its own tenant-specific key. Data and metadata which is shared by all tenants (e.g., database catalog, users, shared containers) may be encrypted in persistent storage using a database instance-specific key.

Such encryption may prevent data leakage and provide defense in case of a third-party breach. The keys may be customer-supplied and can be controlled (i.e., revoked) to prevent the database provider from accessing customer data. In a multi-tenant scenario, where the database system may include data of two or more customers, revocation of a key by a particular customer only renders the data of that particular customer inaccessible. Such customer control may decrease potential liability of the database provider if confidential customer data becomes public and the source of data leakage cannot be identified.

Prior to storing data in persistent storage, a corresponding tenant is determined and a tenant-specific key is used to encrypt the data. The encrypted data is then stored in the persistent storage. In order to load the data from persistent storage into memory, the tenant-specific key is used to decrypt the data. The data may then be loaded into memory. The keys described herein may comprise symmetric keys used for both encryption and decryption, and will be referred to herein as keys or encryption keys regardless of whether they are being used to perform encryption or decryption.

The keys may be stored in a file system of a secure store in an encrypted format. According to some embodiments, a secure store includes a configuration database and one or more payload databases. Each payload database is associated with the database instance or with a specific tenant of the database instance and includes keys of the associated instance or tenant, thereby providing clear separation between the keys of each tenant. The database instance may request keys from the secure store but does not have direct access to the keys themselves because they are stored in an encrypted format.

The configuration database includes information usable to access the keys stored in the payload databases of the database instance and of each tenant thereof. The information may include a key for decrypting a particular payload database, or the identity of a key management system which stores an external key which may be used to perform the decryption. The information for each tenant is clearly separated from that of each other tenant so that it is possible to separately manage the tenants. Each tenant may therefore be associated with a different external key management system and revocation of a given external key from an external key management system will only affect the tenant data associated with that external key.

Embodiments may further provide logic required to independently manage tenant-specific keys and to backup multiple payload databases. Moreover, serving all tenants of a database instance from a single secure store data server process reduces memory and processor requirements in comparison to executing a dedicated secure store data server process for each tenant. Database orchestration is also simplified as only one single secure store data server process must be started and stopped in concert with the lifecycle of the database instance.

According to some embodiments, a native multi-tenant database system includes a database-level tenant object (e.g., a database catalog object) which facilitates the implementation of multi-tenant architectures on the application layer. A tenant object is a logical collection of data as well as metadata artifacts which have been assigned to a tenant. Tenants may be exposed as first-class database objects (i.e., having an identity independent of any other database entity).

The database artifacts assigned to a particular instantiation of a tenant object (i.e., a particular tenant) may include, but are not limited to, data of one or more schemas, tables, and partitions, as well as metadata defining views on the tenant's tables, virtual tables, caches, remote sources, workload classes used to govern resource usage for the tenant's database objects, and database users. In some embodiments, dropping of a tenant from a database instance results in dropping of artifacts assigned thereto, so long as those artifacts are not assigned to another tenant of the database instance.

A native multi-tenant database system may include one or more database instances, the data of all tenants, and the engines for processing the data. The single system also includes a single persistence for the data of all the tenants. By allowing multiple, independent tenants, or rather customers, to be hosted on a single instance and share computing resources, deployment of a new tenant to a database instance is associated with a near-zero marginal cost. The latter comes at a cost of lower physical isolation between the different tenants. Moreover, embodiments enable a pay-per-use model having a finer granularity than that required for provisioning a separate database instance.

A database system according to some embodiments supports requests for tenant-level database operations which would otherwise need to be implemented by the application. These operations may include tenant creation, tenant drop, tenant move, tenant restore from backup, tenant clone, tenant resize and tenant resource limitation. In some embodiments, a shared service exposes APIs (e.g., via REST) which are called by multi-tenant applications to request these tenant-level operations from the database system using, for example, an associated tenant id. Current database system DDLs may be extended to support the assignment of database artefacts to tenants.

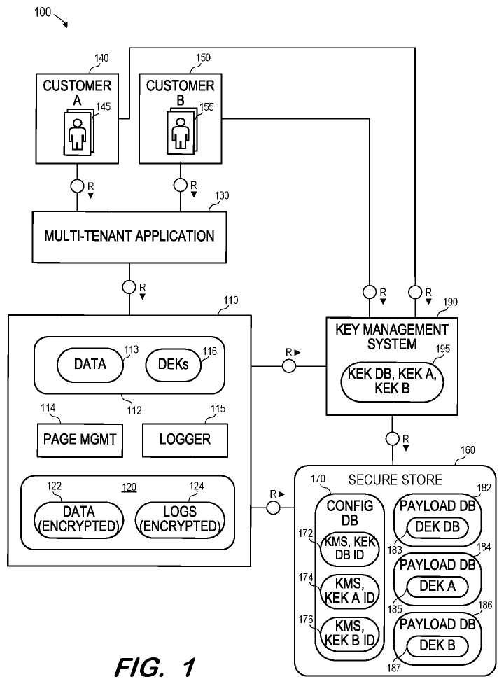

FIG. 1 is a block diagram of system 100 at runtime according to some embodiments. The illustrated elements of system 100 and of all other architectures depicted herein may be implemented using any suitable combination of computing hardware and/or processor-executable program code that is or becomes known. Such combinations may include one or more programmable processors (microprocessors, central processing units, microprocessor cores, execution threads), one or more non-transitory electronic storage media, and processor-executable program code. In some embodiments, two or more elements of system 100 are implemented by a single computing device, and/or two or more elements of system 100 are co-located. One or more elements of system 100 may be implemented as a cloud service (e.g., Software-as-a-Service, Platform-as-a-Service) using cloud-based resources, and/or other systems which apportion computing resources elastically according to demand, need, price, and/or any other metric.

Database instance 110 provides native multi-tenancy according to some embodiments. Database instance 110 may be provisioned on any suitable combination of hardware and software, including one or more computer servers or virtual machines. In some embodiments, database instance 110 comprises a containerized application executing within a software container. Such containers may be implemented by one or more nodes of a cluster (e.g., a Kubernetes cluster) as is known in the art.

Each tenant of system 100 will be described as corresponding to a customer, where a customer may be a company, a division, a workgroup, or any other group of users. A tenant may correspond to a particular cloud resource/service subscription of a given customer. In this regard, a customer may be associated with more than one subscription and therefore more than one tenant.

Database instance 110 includes volatile (e.g., Random Access) memory 112. Memory 112 includes data 113 which includes row store tables, column store tables, and system tables. As is known in the art, the data of each row of a row store table is stored in contiguous memory locations of memory 112, and the data of columns of column store tables is stored in contiguous memory locations of memory 112. The system tables may store metadata defining a database catalog, users, etc. Memory 112 also stores program code and stack, and memory required for temporary computations and database management.

Memory 112 also includes data encryption keys (DEKs) 116 corresponding to each tenant of database instance 110 and to database instance 110 itself. Prior to storing data 113 in persistent storage (e.g., during a savepoint), a tenant to which the data is assigned is determined and one of DEKs 116 corresponding to the tenant is used to encrypt the data. If the data is not assigned to any tenant, a DEK 116 corresponding to database instance 110 is used to encrypt the data. The encrypted data is then stored in the persistent storage.

Database instance 110 requests DEKs from secure store 160 to perform the above-described encryption. Secure store 160 stores DEKs in encrypted format and provides DEKs to database instance in unencrypted format as described below. The unencrypted DEKs are stored in volatile memory 112 as DEKs 116, but are not persisted in database instance 110.

Data 113 includes multiple instances of a tenant object defined in the metadata. Each tenant instance is a collection of database artifacts, where the artifacts assigned to each tenant instance are stored within data 113. The database artifacts assigned to a tenant instance may include, for example, one or more schemas, tables, and partitions. The database artifacts may also include metadata defining views on the tenant's tables, virtual tables, caches, remote sources, workload classes used to govern resource usage for the tenant's database objects, and database users.

Multi-tenant application 130 may comprise a SaaS application but embodiments are not limited thereto. Multi-tenant application 130 may be provisioned on one or more computer servers or virtual machines and may comprise a containerized application executing within a software container. Multi-tenant application 130 issues queries (e.g., SQL, MDX) to database instance 110 based on input received from users 145 and 155 of customers 140 and 145, respectively.

It will be assumed that customer A 140 corresponds to a first tenant of database instance 110 and that customer B 150 corresponds to a second tenant of database instance 110. Upon receipt of input from a user 145 of customer A 140, multi-tenant application 130 may transmit a query to database instance 110 which indicates an association with the first tenant. Similarly, upon receipt of input from a user 145 of customer B 150, multi-tenant application 130 may transmit a query to database instance 110 along with an indication that the query is associated with the second tenant.

Accordingly, multi-tenant application 130 is able to determine the tenant which corresponds to a user from whom input is received. For example, each user may logon to multi-tenant application 130 using a tenant-specific subscription. Multi-tenant application 130 therefore associates a user with the tenant of the subscription under which the user has logged on. In another example, communications between users and multi-tenant application 130 may include tenant-identifying tokens.

Multi-tenant application 130 is also aware of which tenants are placed on which database instances. In this regard, multi-tenant application 130 may request provisioning of database instances and creation of tenants on provisioned database instances. Upon receiving input from a user associated with a given tenant, multi-tenant application 130 is able to determine the database instance which includes the given tenant and to which a corresponding query should therefore be directed.

Upon receipt of a query from multi-tenant application 130, database instance 110 processes the query using the artifacts (e.g., row store tables) which have been assigned to the particular tenant with which the query is associated. Each time a query received from an application consists of a transaction on data in memory 112, the transaction is logged as a log entry of a log segment stored within data 113. The pre-transaction version of the data page is stored as an undo data page, and the data page as changed by the transaction is marked as “dirty”. Periodically, and as is known in the art, a savepoint is created by writing the dirty data pages and the corresponding undo data pages of data 113 to persistent storage 120.

Persistent storage 120 persists encrypted data of all assigned tenants. Persistent storage 120 may be implemented using any persistent data storage system that is or becomes known, including but not limited to distributed data storage systems. Persistent storage 120 includes data volume 122 and log volume 124.

An encryption key associated with database instance 110 may be generated and stored in secure store 160 at creation of database instance 110. An encryption key associated with a given tenant may be generated and stored in secure store 160 upon creation of the given tenant. As mentioned above, secure store 160 may include configuration database 170 and one or more payload databases 182, 184, 186.

Payload database 182 is associated with database instance 110 and includes key DEK DB used to encrypt and decrypt data assigned to database instance 110 (i.e., not assigned to any tenant). Payload database 184 is associated with a Tenant A of database instance 110 and includes key DEK A used to encrypt and decrypt data assigned to Tenant A, while payload database 186 is associated with a Tenant B of database instance 110 and includes key DEK B used to encrypt and decrypt data assigned to tenant B.

Configuration database 170 includes information usable by secure store 160 to access key management system 190 and access a desired key encryption key (KEK). In the illustrated example, KEK DB 195 is used to encrypt and decrypt DEK DB 183 of payload database 182, KEK A 196 is used to encrypt and decrypt DEK A 185 of payload database 184, and KEK B 197 is used to encrypt and decrypt DEK B 187 of payload database 186. Accordingly, the decryption keys stored in payload databases 182, 184 or 186 cannot be used to decrypt data persisted in storage 120 unless they are first decrypted using a corresponding KEK of key management system 190.

In particular, key management system 190 stores KEKs dedicated to database instance 110 or to customers 140, 150. For example, the database instance provider (not shown) provides KEK DB 195, a key user 145 of customer A 140 provides KEK A 196, and a key user 155 of customer B 150 provides KEK B 197.

Configuration database 170 of the present example stores three independently-accessible data portions 172, 174 and 176. Data portion 172 is associated with database instance 110, and includes an identifier of KEK DB 195 and information for accessing key management system 190 (e.g., a URL). Data portion 174 is associated with Tenant A and includes an identifier of KEK A 196 and information for accessing key management system 190. Data portion 176 similarly includes an identifier of KEK B 197 and information for accessing key management system 190.

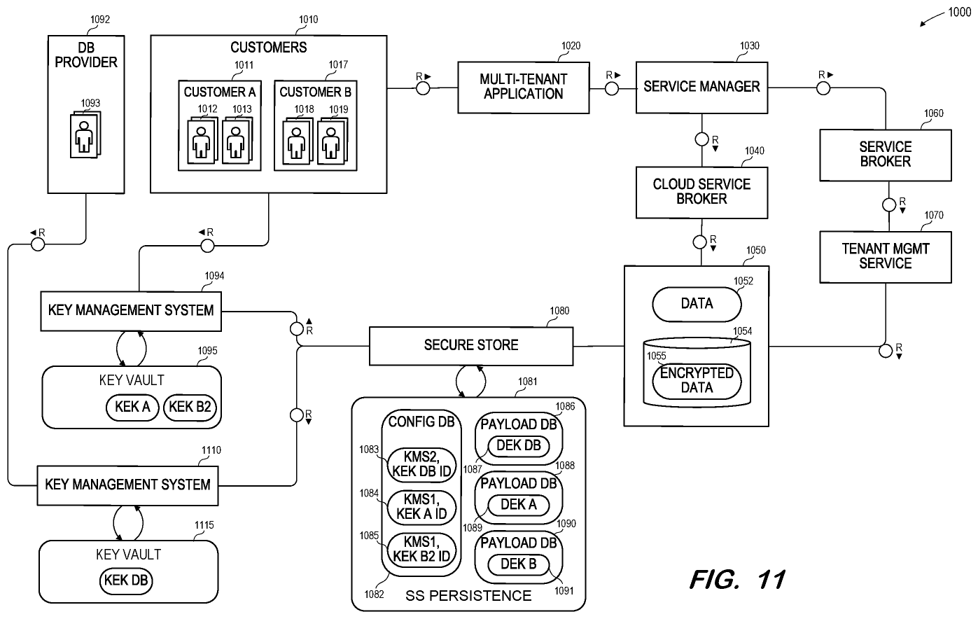

In order to decrypt persisted data 122, page management component 114 requests the corresponding (i.e., tenant-specific or database-specific) key from secure store 160. Since the corresponding key is stored in encrypted format, secure store 160 must request decryption of the encrypted key. Secure store 160 therefore uses configuration database 170 to determine and access a key management system corresponding to the tenant/instance of the encrypted key and to request decryption of the encrypted key using a KEK which is stored in the key management system and corresponds to the tenant/instance. As described with respect to FIG. 11 below, different customers may provide KEKs to different key management systems, each of which may be accessed by secure store 160. In response to the request, the key management system decrypts the key using the KEK and returns the decrypted key to secure store 160. In some embodiments, secure store 160 sends ciphertext of the encrypted key to the key management system and receives decrypted ciphertext therefrom.

If page management component 114 requests the key associated with Tenant A of customer 140, secure store 160 reads the decryption key of DEK A 185 of payload database 184, because payload database 184 is associated with Tenant A. Secure store 160 also identifies data portion 174 of configuration database 170 as associated with Tenant A and reads the key management system information and KEK identifier (i.e., KEK A ID) therefrom. The key management system information is used to transmit encrypted DEK A 185 and KEK A ID to key management system 190, which decrypts DEK A 185 and returns the decrypted key to secure store 160 for use by page management component 114.

Accordingly, if customer A interacts with key management system 190 to revoke KEK A, key management system 190 will be unable to decrypt DEK A 185. Consequently, page management component 114 cannot decrypt data of data 122 which are associated with artifacts assigned to tenant A. Secure store 160 may thereafter decline all future requests from database instance 110 which refer to tenant A.

In some embodiments, each payload database of secure store 160 may store one active DEK and zero or more inactive DEKs in order to support database snapshots. For example, at the beginning of a savepoint, database instance 110 fetches the active DEKs of all payload databases from secure store 160, stores the DEKs as DEKs 116 in memory 112, and uses the keys to encrypt data while writing the savepoint. At the start of a next savepoint, any changes to the active root keys (e.g., via key rotation or key revocation) will be noticed.

Database instance 110 may store a list of revoked keys. If a tenant-specific key is revoked, then the tenant may be marked as disabled, the data that is assigned to this tenant is unloaded from memory 112, and the data may be physically removed from storage 120. Application 130 will therefore receive an error if it attempts to access data of a disabled tenant and, in response, will clean up its own tables respective to this tenant and call a procedure to remove all of the tenant's data from storage 120.

In some embodiments, secure store 160 polls key management system 190 to determine whether any KEKs have been revoked. To avoid hundreds of polls arising from one local secure store installation supporting hundreds of tenants, key management system 190 may provide a grouping mechanism that allows secure store 160 to acquire KEK updates for all of its tenants using a few calls. Similarly, database instance 110 polls secure store 160 to determine whether the KEKs of any of its tenants have been revoked.

Logger component 115 writes a log entry to log volume 124 for each committed transaction during runtime operation of database instance 110. Each saved log entry is encrypted using a DEK associated with the database artifact of the transaction represented by the log entry.

Database instance 110 thereby provides a single data server including the data and metadata of all tenants of database instance 110, the engines for processing the data, and a single persistence for the data and metadata. Hosting multiple independent tenants on such a single database instance facilitates sharing of computing resources at near-zero marginal cost.

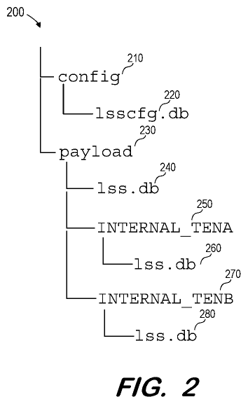

FIG. 2 is a diagram of file directory 200 including configuration and payload databases according to some embodiments. File directory 200 may comprise a directory of a physical storage system (e.g., a hard disk) of secure store 160. Embodiments are not limited to the structure of file directory 200.

File directory 200 includes config folder 210 in which configuration database lsscfg.db 220 is stored. As mentioned above with respect to configuration database 170, configuration database lsscfg.db 220 stores independently-accessible data portions corresponding to a KEK of a database instance and to a KEK for each tenant of the database instance. Each data portion includes an identifier of its corresponding KEK and information for accessing the KEK in a key management system 190 (e.g., a URL) or, alternatively, the KEK itself.

File directory 200 also includes payload folder 230 at a same hierarchical level as config folder 210. Payload folder 230 includes payload database lss.db 240 associated with the database instance. Accordingly, payload database lss.db 240 stores the DEK for the database instance.

Payload folder 230 also includes sub-folders for each internal tenant of the database instance. Sub-folder INTERNAL TENA 250 includes payload database lss.db 260 associated with Tenant A and therefore stores the DEK for Tenant A. Sub-folder INTERNAL TENA 270 includes payload database lss.db 280 associated with Tenant B and therefore stores the DEK for Tenant B. The DEKs stored in each of payload databases 240, 260 and 280 are stored in encrypted format (i.e., encrypted by the KEK corresponding to the payload database as indicated by configuration database 220).

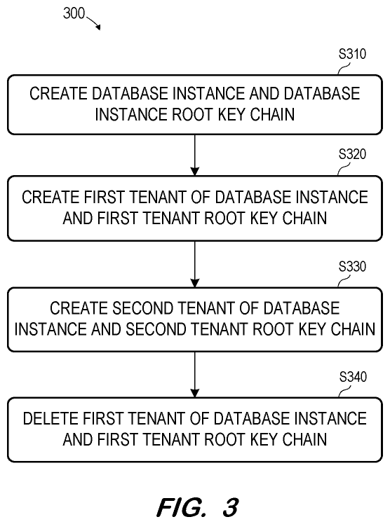

FIG. 3 is a flow diagram of process 300 for creating tenant-specific keys according to some embodiments. Process 300 and all other processes mentioned herein may be embodied in program code executable by one or more processing units (e.g., processor, processor core, processor thread) and read from one or more of non-transitory computer-readable media, such as a hard disk drive, a volatile or non-volatile random access memory, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S310, a database instance and a corresponding database instance root key chain are created. The database instance may be created as is known in the art based on one or more commands received from a database administrator. The commands may include commands for creating and activating a root key chain associated with the database instance.

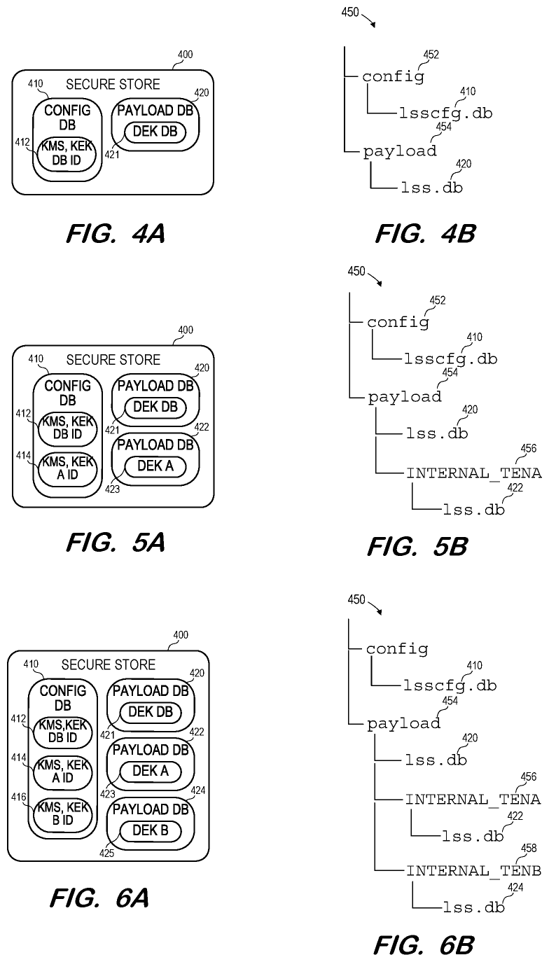

FIG. 4A illustrates secure store 400 and FIG. 4B illustrates secure store file directory 450 after S310 in some embodiments. S310 has resulted in creation of configuration database 410 and payload database 420. Payload database 420 is associated with the database instance and includes DEK 421 which serves as the root key chain thereof.

Configuration database 410 in the present example includes information for accessing a key management system which stores a KEK used to decrypt DEK DB 421, and an identifier of that KEK. Accordingly, prior to the state depicted in FIGS. 4A and 4B, the KEK may be stored in the key management system by a provider of the database instance and secure store 400 may be provided with the access information and the KEK identifier for storage in configuration database 410.

A first tenant of the database instance and a corresponding first tenant root key chain are created at S320. Creation of the first tenant may comprise instantiation of a tenant database object as described above, and may be initiated based on one or more commands received from a database administrator. The commands may include commands for creating and activating a root key chain associated with the tenant.

FIG. 5A illustrates secure store 400 and FIG. 5B illustrates secure store file directory 450 after S320 according to some embodiments. Newly-created payload database 422 is associated with the first tenant (e.g., Tenant A) and includes DEK A 423 which serves as the root key chain for the first tenant. Configuration database 410 now includes portion 414 storing information for accessing a key management system which stores a KEK (e.g., KEK A) used to decrypt DEK A 423, and an identifier of that KEK (i.e., KEK A ID). KEK A may be stored in the key management system by a customer corresponding to Tenant A of the database instance and secure store 400 may be provided with the access information and the KEK identifier for storage in portion 414 of configuration database 410.

Continuing the present example, a second tenant of the database instance and a corresponding second tenant root key chain are created at S330. The second tenant may be associated with a second customer of the database instance provider. Creation of the second tenant may also comprise instantiation of a tenant database object based on one or more commands received from a database administrator.

FIG. 6A illustrates secure store 400 and FIG. 6B illustrates secure store file directory 450 after S330 according to some embodiments. Payload database 424 is associated with the second tenant (e.g., Tenant B) and includes DEK B 424 which serves as the root key chain for the second tenant. Portion 416 has been added to configuration database 410 for storing information for accessing a key management system which stores a KEK (e.g., KEK B) used to decrypt DEK B 425, and an identifier of that KEK (i.e., KEK B ID). KEK B may be stored in the key management system by the customer corresponding to Tenant B of the database instance. Due to the structure of portions 412, 414 and 416, different key management systems may be supported by a single database instance. Moreover, the key management system associated with a given tenant or with the database instance may be efficiently updated.

Next, at S340, the first tenant of the database instance is deleted. For example, a database administrator may issue a command to delete the first tenant. As part of the deletion process, the first tenant root key chain is deleted. Deletion of the first tenant may also include deletion of all database artifacts assigned to the first tenant.

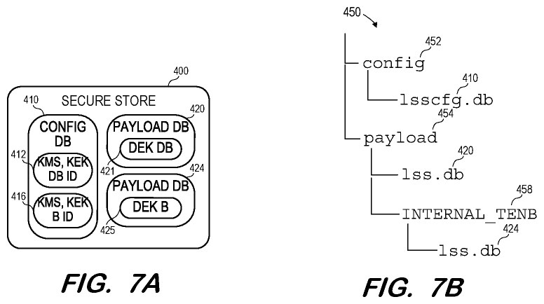

FIG. 7A illustrates secure store 400 and FIG. 7B illustrates secure store file directory 450 after S340 according to some embodiments. Deletion of Tenant A has caused deletion of payload database 422 (and of folder INTERNAL TENA storing payload database 422). Configuration database 410 is also updated to remove portion 414 corresponding to Tenant A. Accordingly, the associated database instance is no longer able to decrypt any persisted encrypted data artifacts associated with the deleted tenant.

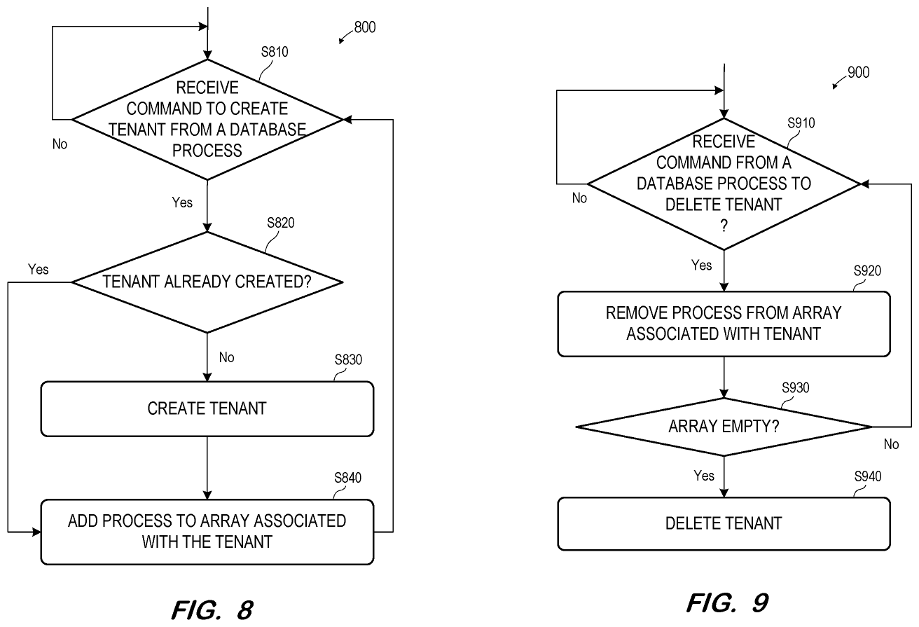

FIGS. 8 and 9 are flow diagrams of a reference counting process to create and delete a tenant of a database instance, respectively. A database instance in some embodiments executes several independent processes, each of which accesses tenant data. A second process will not be aware that a first process has created a tenant and may therefore attempt to create an already-created tenant. Similarly, since the first process is not aware of a second process which uses a same tenant, the first process may attempt to delete the tenant while the second process continues to use the tenant.

Process 800 of FIG. 8 may be implemented to provide tenant creation in the above-described multi-process scenario. Initially, flow cycles at S810 until a command is received from a database process to create a tenant. At S820, it is determined whether the tenant has already been created. In the present example, it will be assumed that a command to create Tenant A was received at S810 from a first process and that Tenant A has not yet been created. Accordingly, flow proceeds from S820 to S830 to create Tenant A within the database system. Creation of a tenant, as described above, may comprise instantiation of a corresponding tenant database object within the database instance, creation of a payload database, and update of a configuration database within a secure store.

Next, at S840, an identifier of the process from which the command was received (e.g., the first process) at S810 is added to an array associated with the tenant (e.g., Tenant A). The identifier may comprise a volume ID if each volume ID is specific to a single process, and the volume ID (or any other suitable string) may be passed in the create tenant command to the secure store. The array may be persisted on disk in the configuration database of the secure store in order to survive a restart of the secure store.

Flow returns to S810 to await a next command. Assuming that a command to create Tenant A is then received from a second process at S810, it is determined at S820 that Tenant A has already been created. Flow therefore proceeds to S840 to add the process from which the command was received (e.g., the second process) to the array associated with Tenant A.

Flow continues as described above to populate the array with identifiers of all processes using the created tenant. If a command to create another tenant is received at S810, an array for that tenant is created and populated as described above. As will be described with respect to process 900 of FIG. 9, the arrays are used to determine whether or not to delete a tenant in response to a command to do so.

At S910, flow cycles until a command is received to delete a tenant from a database process. In response, an array associated with the tenant is identified and the process (which presumably issued a prior command to create the tenant) is removed from the array. Next, at S930, it is determined whether the array is empty. If not (i.e., identifiers of one or more other database processes remain in the array), flow returns to S910. If the array is empty, it is assumed that no other processes are using the tenant and that the tenant may therefore be safely deleted. Accordingly, the tenant is deleted at S940. Deletion may include deletion of the tenant object, all data artifacts assigned to the tenant, the payload database associated with the tenant, and the portion of the configuration database corresponding to the tenant within the secure store.

In order to account for processes which issue a create tenant command and are stopped prior to issuing a delete tenant command, the delete tenant command may include an identifier (e.g., volume ID) of the calling process as well as identifiers of each other currently-executing process. The identifiers may be compared against the array to remove any non-executing processes from the array.

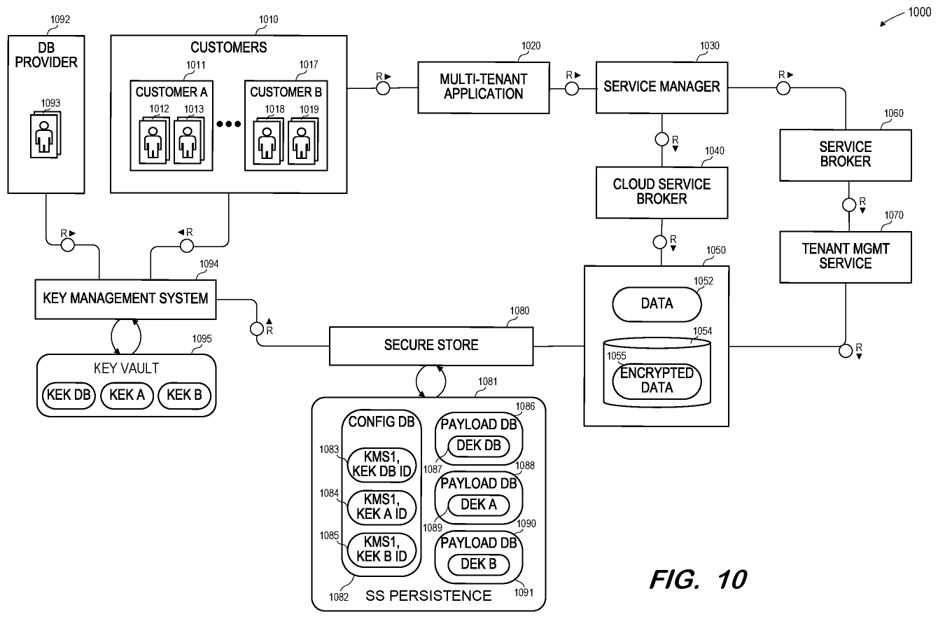

FIG. 10 is a block diagram of system 1000 providing native multi-tenancy and tenant-level encryption according to some embodiments. Database instance 1050 stores data 1052 within volatile memory at runtime as described above with respect to data 113. Volatile memory of instance 1050 also includes DEKs, free memory, etc. Persistence 1054 of instance 1050 stores encrypted data 1055 as described above.

Each tenant instance of database instance 1050 corresponds to a respective one of customers 1010. Customer A 1011 includes key users 1012 and business users 1013, and customer B 1017 includes key users 1018 and business users 1019. In some examples, a key user 1012 may access multi-tenant application 1020 to request provisioning of a database instance. Provisioning of database instance 1050 may include generation of DEK DB 1087 and payload database 1086, and configuration database 1082 including portion 1083.

A tenant object instance may then be created in database instance 1050. Continuing the above example, a key user 1012 may access multi-tenant application 1020 to request creation of a tenant on database instance 1050. In response, database instance 1050 creates an instance of Tenant A based on a tenant object defined in metadata of data 1052. The instance of Tenant A may be identified by a tenant ID which is known to database instance 1050 and multi-tenant application 1020. Also created are DEK A 1089 and payload database 1088, and portion 1084 of configuration database 1082.

A key user 1018 of customer B 1017 may also access multi-tenant application 1020 to request creation of a tenant on database instance 1050. In response, database instance 1050 creates an instance of Tenant B in data 1052. Multi-tenant application 1020 further instructs tenant management service 1070 to assign artifacts to the tenant B instance. DEK B 1091 and payload database 1090 are also created, along with portion 1085 of configuration database 1082.

After provisioning database instance 1050 and creating Tenants A and B, multi-tenant application 1020 may, for example, receive input from a business user 1013 of customer A 1011. In response, application 1020 directs any resulting queries to database instance 1050 along with an identifier of Tenant A. Database instance 1050 therefore responds to the queries based on artifacts assigned to Tenant instance A. In a case that multi-tenant application 1020 receives input from a business user 1019 of customer B 1017, any resulting queries are directed to database instance 1050 and responded to based on artifacts assigned to tenant instance B.

Each of portions 1083, 1084 and 1085 includes information (i.e., KMS1) for accessing key management system 1094. A key user 1093 of database instance provider 1092 provides KEK DB to key management system 1094 for storage in key vault 1095. KEK DB is used to encrypt DEK DB 1087 prior to storage thereof in payload database 1086. Database instance 1050 requests DEK DB from secure store 1080 when database instance 1050 wishes to decrypt tenant-unassigned data pages, such as during a restart process. In response, secure store 1080 uses portion 1083 to request key management system 1094 to decrypt the stored encrypted DEK DB 1087 using KEK DB. Database instance 1050 then uses the decrypted DEK DB to decrypt the desired tenant-unassigned data pages.

Similarly, a key user 1012 of customer A 1011 provides KEK A to key management system 1094 for storage in key vault 1095. KEK A is used to encrypt DEK A 1089 prior to storage thereof in payload database 1088. Database instance 1050 may request DEK A 1089 from secure store 1080 in order to decrypt data pages of data 1055 which are associated with Tenant A, in order to load thusly-decrypted pages into data 1052. Store 1080 uses portion 1084 to request key management system 1094 to decrypt the stored encrypted DEK A 1089 using KEK A. Database instance 1050 then loads the decrypted DEK A 1089 into its volatile memory and uses the decrypted DEK A 1089 to decrypt the desired data of data 1055.

In some embodiments, secure store 1080 polls key management system 1094 to determine whether any KEKs have been revoked. Database instance 1050 also polls secure store 1080 to determine whether the KEKs of any of its tenants have been revoked and records such revocations. Accordingly, during the loading of a data page from data 1055 to data 1052, it is determined whether a KEK required to decrypt the page has been revoked. If so, the data page is not decrypted or loaded, but its corresponding memory region is freed.

FIG. 11 is a block diagram of system 1000 including second key management system 1110 and corresponding key vault 1115. FIG. 11 illustrates use of payload databases and configuration database portions to efficiently manage KEKs and key management systems.

As shown, portion 1083 of configuration database 1082 has been modified to include information for accessing key management system 1110. Accordingly, when a request is received to decrypt DEK DB 1087, secure store 1080 uses this information to access key management system 1110 and request decryption using KEK DB, which has been moved from key vault 1095 to key vault 1115.

As also shown, the KEK used to encrypt/decrypt DEK B 1091 has changed to KEK B2. Portion 1085 has been updated to include an identifier of KEK B2, which now resides in key vault 1095. In response to a request to decrypt DEK B 1091, secure store 1080 uses accesses key management system 1094 and requests decryption using KEK B2.

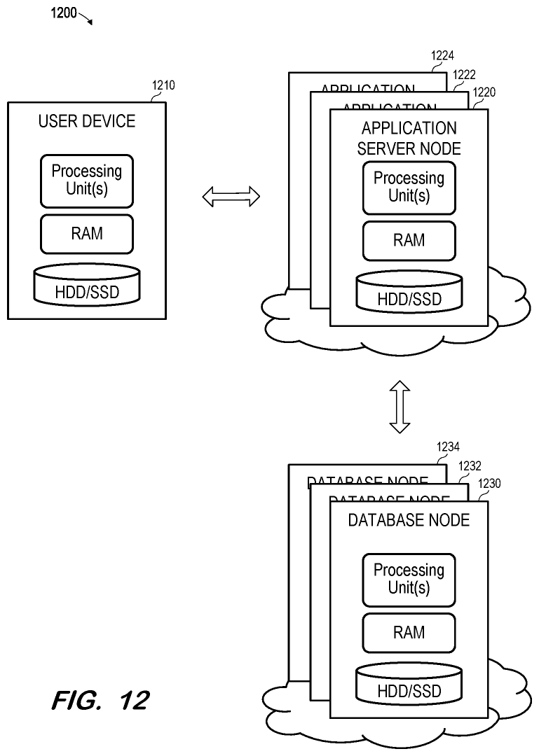

FIG. 12 is a block diagram of cloud-based database deployment 1200 according to some embodiments. User device 1210 may comprise any suitable computing system operable by a key user or a business user to access a cloud-based multi-tenant application. User device 1210 may store and execute program code of a Web browser to access a Uniform Resource Locator (URL) associated with a login page of such a multi-tenant application. The Web browser may download and execute program code of a client-side component of a multi-tenant application as is known in the art.

Application server nodes 1220, 1222 and 1224 may host a multi-tenant application according to some embodiments. Database nodes 1230, 1232 and 1234 may host one or more database instances accessible to the multi-tenant application and providing native multi-tenancy as described herein. Each node of deployment 1200 may comprise a separate physical machine or a virtual machine. Such virtual machines may be allocated by a cloud provider providing self-service and immediate provisioning, autoscaling, security, compliance and identity management features.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device may include a programmable processor to execute program code such that the computing device operates as described herein.

All systems and processes discussed herein may be embodied in program code stored on one or more non-transitory computer-readable media. Such media may include, for example, a DVD-ROM, a Flash drive, magnetic tape, and solid state Random Access Memory (RAM) or Read Only Memory (ROM) storage units. Embodiments are therefore not limited to any specific combination of hardware and software.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

Embodiments described herein are solely for the purpose of illustration. Those in the art will recognize other embodiments may be practiced with modifications and alterations to that described above.

What is claimed is:

1. A system comprising:
a volatile memory storing first data artifacts assigned to a first database tenant object instance and second data artifacts not assigned to a database tenant object instance; and
a storage system storing:
a first payload database comprising a first encryption key for encrypting and decrypting the first data artifacts;
a second payload database comprising a second encryption key for encrypting and decrypting the second data artifacts; and
a configuration database comprising a first portion including information usable for decrypting the first encryption key and a second portion including information usable for decrypting the second encryption key.

2. A system according to claim 1, further comprising:
a key management system storing a third encryption key for encrypting and decrypting the first encryption key and a fourth encryption key for encrypting and decrypting the second encryption key,
wherein the information usable for decrypting the first encryption key comprises information for accessing the key management system and identifying the third encryption key, and
wherein the information usable for decrypting the second encryption key comprises information for accessing the key management system and identifying the fourth encryption key.

3. A system according to claim 1, further comprising:
a first key management system storing a third encryption key for encrypting and decrypting the first encryption key; and
a second key management system storing a fourth encryption key for encrypting and decrypting the second encryption key,
wherein the information usable for decrypting the first encryption key comprises information for accessing the first key management system and identifying the third encryption key, and
wherein the information usable for decrypting the second encryption key comprises information for accessing the second key management system and identifying the fourth encryption key.

4. A system according to claim 1,
the volatile memory storing third data artifacts assigned to a second database tenant object instance,
the storage system storing a third payload database comprising a third encryption key for encrypting and decrypting the third data artifacts, and
the configuration database comprising a third portion including information usable for decrypting the third encryption key.

5. A system according to claim 4, further comprising:
a first key management system storing a fourth encryption key for encrypting and decrypting the first encryption key and a fifth encryption key for encrypting and decrypting the second encryption key; and
a second key management system storing a sixth encryption key for encrypting and decrypting the third encryption key,
wherein the information usable for decrypting the first encryption key comprises information for accessing the first key management system and identifying the fourth encryption key,
wherein the information usable for decrypting the second encryption key comprises information for accessing the first key management system and identifying the fifth encryption key, and
wherein the information usable for decrypting the third encryption key comprises information for accessing the second key management system and identifying the sixth encryption key.

6. A system according to claim 1, further comprising:
a processing unit to execute program code to cause the system to:
receive a command to delete the first database tenant object instance; and
in response to the command, delete the first payload database from the storage system and delete the first portion of the configuration database.

7. A system according to claim 6, wherein the command is received from a database process, and the processing unit to execute program code to cause the system to:
in response to the command and before deletion of the first payload database and the first portion, determine that no other executing database processes are using the first database tenant object instance.

8. A method comprising:
assigning first data artifacts to a first database tenant object instance;
storing a first payload database comprising a first encryption key for encrypting and decrypting the first data artifacts;
storing a second payload database comprising a second encryption key for encrypting and decrypting second data artifacts not assigned to a database tenant object instance; and
storing a configuration database comprising a first portion including information usable for decrypting the first encryption key and a second portion including information usable for decrypting the second encryption key.

9. A method according to claim 8, further comprising:
storing, in a key management system, a third encryption key for encrypting and decrypting the first encryption key and a fourth encryption key for encrypting and decrypting the second encryption key,
wherein the information usable for decrypting the first encryption key comprises information for accessing the key management system and identifying the third encryption key, and
wherein the information usable for decrypting the second encryption key comprises information for accessing the key management system and identifying the fourth encryption key.

10. A method according to claim 8, further comprising:
storing, in a first key management system, a third encryption key for encrypting and decrypting the first encryption key; and
storing, in a second key management system, a fourth encryption key for encrypting and decrypting the second encryption key,
wherein the information usable for decrypting the first encryption key comprises information for accessing the first key management system and identifying the third encryption key, and
wherein the information usable for decrypting the second encryption key comprises information for accessing the second key management system and identifying the fourth encryption key.

11. A method according to claim 8, further comprising:
storing third data artifacts assigned to a second database tenant object instance;
storing a third payload database comprising a third encryption key for encrypting and decrypting the third data artifacts; and
storing, in the configuration database, a third portion including information usable for the third encryption key.

12. A method according to claim 11, further comprising:
storing, in a first key management system, a fourth encryption key for encrypting and decrypting the first encryption key and a fifth encryption key for encrypting and decrypting the second encryption key; and
storing, in a second key management system, a sixth encryption key for encrypting and decrypting the third encryption key,
wherein the information usable for decrypting the first encryption key comprises information for accessing the first key management system and identifying the fourth encryption key,
wherein the information usable for decrypting the second encryption key comprises information for accessing the first key management system and identifying the fifth encryption key, and
wherein the information usable for decrypting the third encryption key comprises information for accessing the second key management system and identifying the sixth encryption key.

13. A method according to claim 8, further comprising:
receiving a command to delete the first database tenant object instance; and
in response to the command, deleting the first payload database and deleting the first portion of the configuration database.

14. A method according to claim 13, wherein the command is received from a database process, the method further comprising:
in response to the command and before deletion of the first payload database and the first portion, determining that no other executing database processes are using the first database tenant object instance.

15. A non-transitory computer-readable medium storing program code executable by one or more processing units to cause a computing system to:
assign first data artifacts stored in a volatile memory to a first database tenant object instance stored in the volatile memory;
store, in a persistent storage system, a first payload database comprising a first encryption key for encrypting and decrypting the first data artifacts;
store, in the persistent storage system, a second payload database comprising a second encryption key for encrypting and decrypting second data artifacts not assigned to a database tenant object instance; and
store, in the persistent storage system, a configuration database comprising a first portion including information usable for decrypting the first encryption key and a second portion including information usable for decrypting the second encryption key.

16. A medium according to claim 15, the program code executable by one or more processing units to cause a computing system to:
store, in a key management system, a third encryption key for encrypting and decrypting the first encryption key and a fourth encryption key for encrypting and decrypting the second encryption key,
wherein the information usable for decrypting the first encryption key comprises information for accessing the key management system and identifying the third encryption key, and
wherein the information usable for decrypting the second encryption key comprises information for accessing the key management system and identifying the fourth encryption key.

17. A medium according to claim 15, the program code executable by one or more processing units to cause a computing system to:
store, in a first key management system, a third encryption key for encrypting and decrypting the first encryption key; and
store, in a second key management system, a fourth encryption key for encrypting and decrypting the second encryption key,
wherein the information usable for decrypting the first encryption key comprises information for accessing the first key management system and identifying the third encryption key, and
wherein the information usable for decrypting the second encryption key comprises information for accessing the second key management system and identifying the fourth encryption key.

18. A medium according to claim 15, the program code executable by one or more processing units to cause a computing system to:
store, in the volatile memory, third data artifacts assigned to a second database tenant object instance;
store, in the persistent storage system, a third payload database comprising a third encryption key for encrypting and decrypting the third data artifacts; and
store, in the configuration database, a third portion including information usable for decrypting the third encryption key.

19. A medium according to claim 18, the program code executable by one or more processing units to cause a computing system to:
store, in a first key management system, a fourth encryption key for encrypting and decrypting the first encryption key and a fifth encryption key for encrypting and decrypting the second encryption key; and
store, in a second key management system, a sixth encryption key for encrypting and decrypting the third encryption key,
wherein the information usable for decrypting the first encryption key comprises information for accessing the first key management system and identifying the fourth encryption key,
wherein the information usable for decrypting the second encryption key comprises information for accessing the first key management system and identifying the fifth encryption key, and
wherein the information usable for decrypting the third encryption key comprises information for accessing the second key management system and identifying the sixth encryption key.

20. A medium according to claim 15, the program code executable by one or more processing units to cause a computing system to:
receiving a command to delete the first database tenant object instance; and
in response to the command, deleting the first payload database from the storage system and deleting the first portion of the configuration database.
